(19) United States
(12) Patent Application Publication
(10) Pub. No.: US 2013/0146685 A1
(43) Pub. Date: Jun. 13, 2013

(54) SYSTEM AND METHOD FOR PRE-CONDITIONING DRILL CUTTINGS FOR TREATMENT AND DISPOSAL

(71) Applicant: LARRY SAIK, INNISFREE (CA)

(72) Inventor: LARRY SAIK, INNISFREE (CA)

(21) Appl. No.: 13/707,477

(22) Filed: Dec. 6, 2012

Related U.S. Application Data
(60) Provisional application No. 61/567,860, filed on Dec. 7, 2011.

(51) Int. Cl. B02C 23/08; B02C 19/06

(52) U.S. Cl. CPC B02C 23/08; B02C 19/06
USPC 241/5; 241/39

(57) ABSTRACT

A system is for conditioning drill cuttings contaminated with hydrocarbons comprises an auger device for feeding an agitation chamber in which the material is washed and separated. The material is conditioned in the agitation chamber by a first conditioning agent for separating the hydrocarbon from the material. The material is crushed to a specific mesh size for further washing and conditioning using a second conditioning agent. The crushed material is then sent to a series of agitation and wash tanks wherein it is serially washed and conditioned until an acceptable concentration of hydrocarbon is achieved. The material can then be disposed.

### CROSS-REFERENCE TO RELATED APPLICATIONS

This application claims the benefit of U.S. Provisional Patent Application No. 61/567,860 filed in the USPTO on Dec. 7, 2011 filed by the present inventor and incorporated herein.

### FEDERAL SPONSORSHIP

N/A

### BACKGROUND OF THE INVENTION

1. Field of the Invention

The present invention relates generally to material washing wherein hydrocarbons are separated from material for subsequent disposal, and more particularly, to a system and method for pre-conditioning of drill cuttings for treatment and disposal.

2. Background

This invention relates to a system and method for washing drill cuttings drill cuttings comprising sand that is contaminated with hydrocarbons. Presently such material is collected and disposed of in open fields. This manner of disposal is no longer acceptable. Environmental regulations are demanding a more ecologically benign solution.

Prior art sand washing systems are used to remove oil from sand and proppants found in field oil storage tanks. In such situations the sand is already in a fine state. However, drill cuttings often resemble a conglomeration of materials both large and small fixed together with drilling mud and the like. The raw material may have between 30,000 ppm and 40,000 ppm of hydrocarbons. Prior art sand washing systems are not effective in removing a sufficient amount of hydrocarbon material from drill cuttings because of their mixed constituents. Therefore, there is a need for a system and method to pre-condition the drill cuttings contaminated with hydrocarbons.

### SUMMARY OF THE INVENTION

My invention comprises a system for pre-conditioning drill cuttings facilitating separating hydrocarbons from drill cuttings. There is an input device for continuously feeding an amount of raw drill cutting material into an agitation chamber. The raw material is usually in the form of a conglomerate. The agitation chamber has an interior volume. There is at least one source of high pressure water penetrated into the interior volume for suspending the raw material in an agitated aqueous solution. This causes the raw material conglomerate to dissociate into a plurality of constituent parts suspended in an aqueous solution. This also causes the formation of hydrocarbon froth on the surface of the fluid within the agitation chamber.

There is also provided at least one source of a plurality of conditioning chemicals penetrating into the interior volume. This source is typically a conduit for metering the conditioning chemicals into the agitation chamber. Typically these conditioning chemicals will comprise a suitable amount of dispersant agent and flocculating agent.

A crusher is disposed at the bottom of the agitation chamber for receiving and crushing the constituent parts into fine mesh particulates suspended in an aqueous solution.

The fines are then transported from the crusher to a final treatment device.

In one embodiment of the system water from the crusher is recycled by pumping at high pressure back to the agitation chamber.

The agitation within the agitation chamber and the addition of dispersant agents will create a surface floating hydrocarbon froth. In another embodiment of the invention there is provided a froth skimmer for skimming the froth and removing it from the agitation chamber for further treatment.

In yet another embodiment of the invention there is provided a cyclonic dryer which receives the aqueous solution of fines from the crusher and separates most of the water from the solution and leaves slurry for transportation to a final treatment device.

The final treatment device comprises an at least one tank separated into a plurality of treatment cells by a plurality of separating walls. The treatment cells are aligned serially in a linear fashion so that slurry is passed through each cell sequentially. Slurry is received at one end of the tank and is moved by an auger from cell to cell. The concentration of hydrocarbon within the slurry at each cell is progressively reduced to a point where the final concentration is less than 250 ppm.

### BRIEF DESCRIPTION OF THE FIGURES

FIG. 1 is a photograph showing raw material contaminated with hydrocarbons.

FIG. 2 is an enlarged photograph of raw material contaminated with hydrocarbons.

FIG. 3 is a schematic diagram of components of one embodiment of the system.

FIG. 4 is a photograph of washed and dissociated raw material ready for crushing.

FIG. 5 is a photograph of crushed material from the auger ready for final treatment.

FIG. 6A is a schematic diagram of one embodiment of the final treatment agitation cells of the invention.

FIG. 6B is another schematic diagram of one embodiment of the final treatment agitation cells showing the water drain pots.

### DESCRIPTION OF THE INVENTION

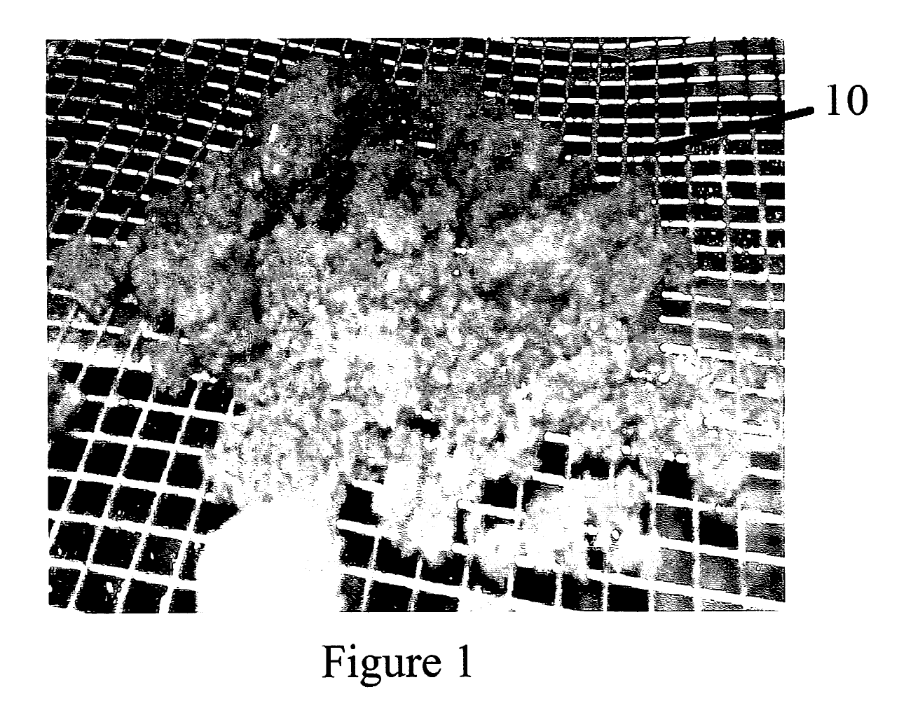

Referring to the FIG. 1 there is shown a colour photograph of the raw feed material 10 that is to be treated by the system. The raw feed material resembles a conglomerate and contains from 30,000 ppm to 40,000 ppm of hydrocarbons. This material is unsuitable for prior-art sand washing devices and requires pre-treatment to remove as much hydrocarbon as possible prior to an at least one final treatment process which may comprise sand washing.

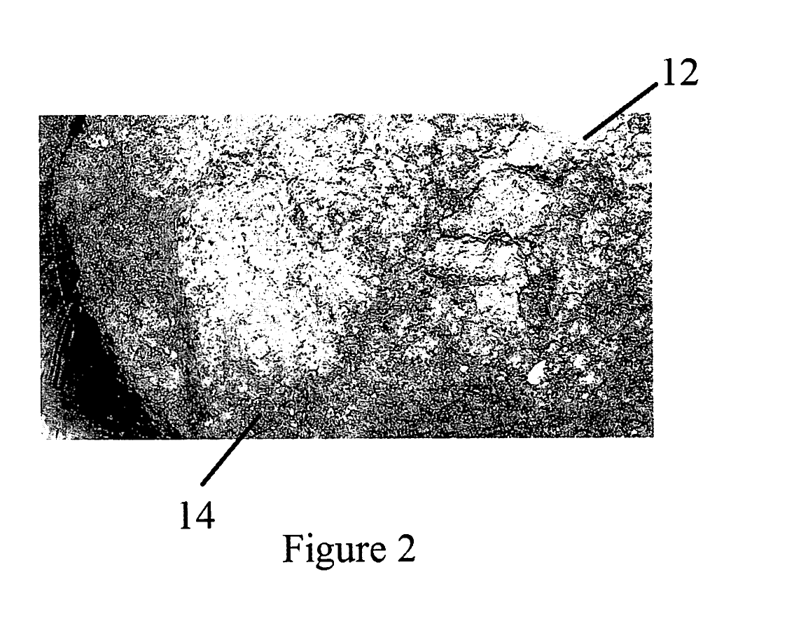

Referring to FIG. 2 there is shown an enlarged colour photograph of raw material 12 wherein hydrocarbon deposits 14 show as blue marks.

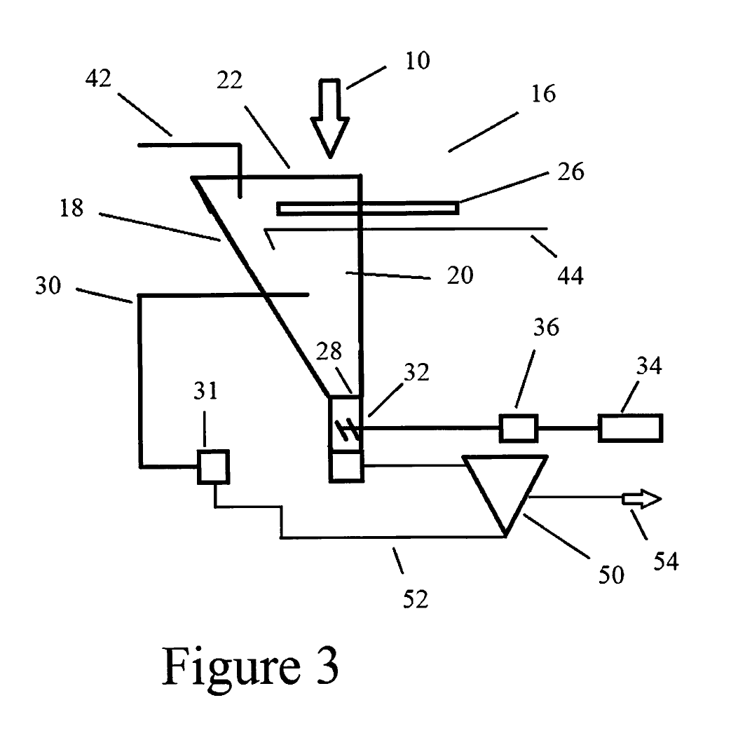

Referring to FIG. 3 there is shown a schematic diagram of one part of the system for pre-conditioning drill cuttings prior to sand washing and subsequent disposal. The system 16 comprises a treatment cell comprising an agitation chamber 18 for washing the raw material and separating the conglomerate into its constituent parts. The agitation chamber 18 has an interior volume 20 and open top 22 into which raw material 10 is feed using a feeding or input device such an auger input device for continual feed. The agitation chambers can be combined in tandem parallel arrangements to treat large volumes of waste material. Once the raw material 10 is disposed into the interior volume 20 it is agitated and washed by high pressure water 26. This causes a dissociation of the conglomerate material into constituent parts, generally, course granular material, proppants and hydrocarbon contaminates.

The raw material is continually washed by recycled water 30 from the washing process until it has dissociated to the extent that it passes through a mesh of a predetermined size screen 28 into a crushing auger 32. The recycled water is pressurized by pump 31

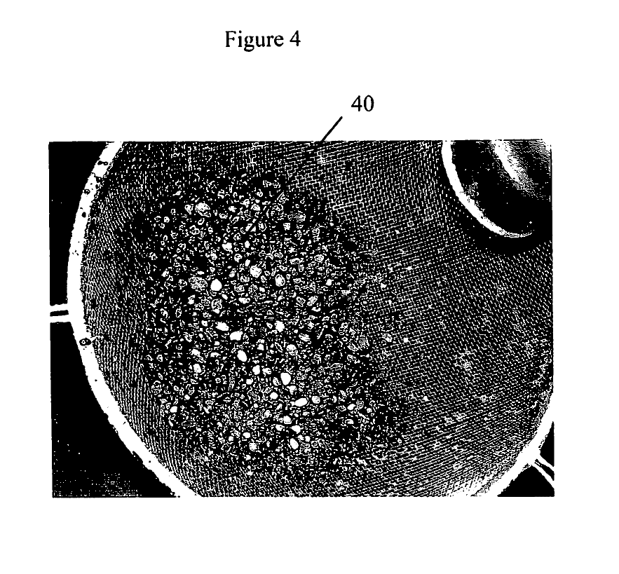

Referring to FIG. 4, there is shown a colour photograph of washed raw material 40 in a totally dissociated form which generally comprises a course granular material. This material is too large for washing and so is then crushed by the crusher into fine sand.

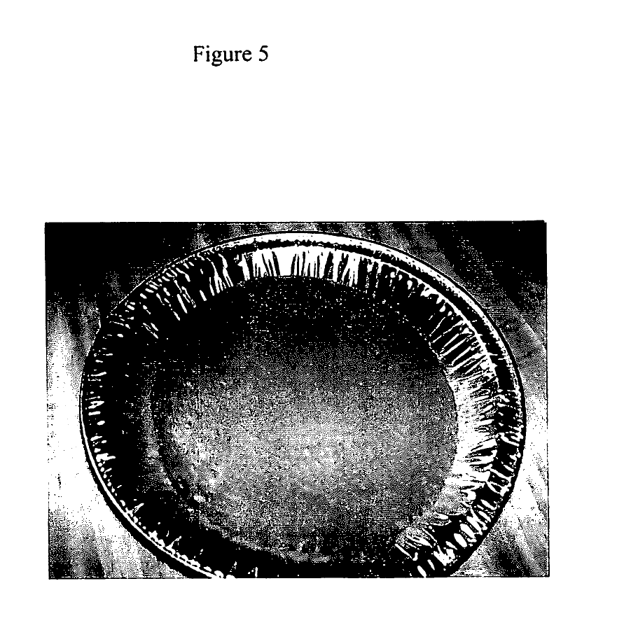

Referring to FIG. 5, there is shown a colour photograph of the crushed raw material from the auger. This material is then separated by cyclonic treatment from the wash water and transferred to a series of agitation chambers for further treatment such as sequential washing and treatment with dispersants and flocculating agents.

The agitation chamber 18 has an inverted truncated triangular shape so that material is continually washed down towards the crushing auger. The auger is driven by an electric motor 34 through a gear box 36.

To promote separation of the hydrocarbons from raw material, surfactants and flocculants are added 42 to the agitation chamber during the washing process. One surfactant that is used is called BREAKAWAY™ by Guardian Chemicals Inc. which is a non-caustic surfactant. A flocculent such as FLOCULANT 165™ is used to clarify the water.

A froth component comprising hydrocarbon contaminants will form on the surface of the water within the agitation chamber 18. This material is skimmed off of the surface by a skimmer 44 and the froth is then sent for processing and recycling.

Crushed material from the auger is then transferred to a cyclonic separator 50 or dryer. Water 52 from the cyclonic separator is sent back to the agitation chamber for further use and the crushed material 54 is transferred to a series of agitation chambers for final processing.

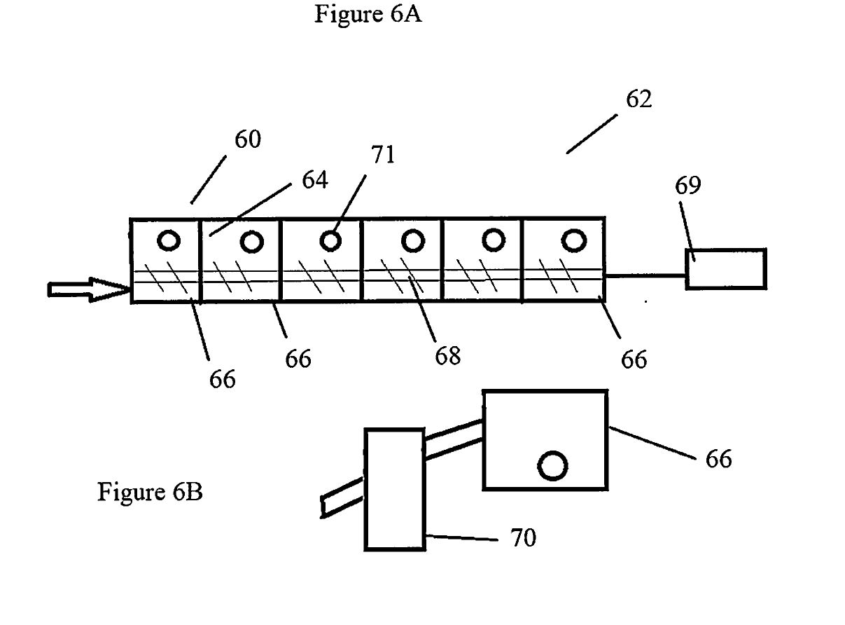

Referring to FIG. 6A, there is shown one model of a final treatment process. The agitation chambers 60 comprise a tank 62 that is compartmentalized by walls 64 into a series of cells 66. An agitation mechanism 68 agitates the material in each cell in a mixture of water and conditioning chemicals such as the dispersal agent and floc agent previously described. The agitation mechanism 68 is an auger device driven by an electric motor 69. Each cell 66 includes an overflow orifice 71 that is connected to a collection pot 70 as shown in FIG. 6B.

Referring to FIG. 6B, water from each cell is permitted to overflow into a collection pot 70. The water is can be further treated for clarification by a backwash treatment for disposal or returned to the agitation chamber 18. The treated material has a final hydrocarbon content of about 250 ppm which is acceptable for land disposal.

A method for pre-conditioning drill cuttings contaminated with hydrocarbons is disclosed comprising the following steps:
a. Providing a source of raw material comprising a conglomeration of drill cuttings contaminated with hydrocarbons;
b. Feeding the raw material into an agitation chamber for separation of the conglomerate raw material into constituent parts;
c. Simultaneously adding a first conditioning agent for promoting the separation of hydrocarbons from the washed raw material;
d. Crushing the washed raw material into fines having a suitable mesh size for further processing;
e. Feeding the crushed raw material into a series of agitation chambers for treatment;
f. Adding a second conditioning agent to each of the series of agitation chambers for promoting hydrocarbon separation from the crushed raw material; and,
g. Collecting from the last agitation chamber the cleaned material for suitable disposal.

As a further step, the aqueous solution from the agitation chambers to is recycled to the agitation chamber.

As a further step floating hydrocarbon contaminated material is skimmed from the agitation chamber using a hydrocarbon skimmer.

What is claimed is:

1) A system for pre-conditioning drill cuttings contaminated with hydrocarbons, said system comprising:
a) an input device for continuously feeding an amount of raw material into an agitation chamber having an interior volume;
b) at least one source of high pressure water penetrated into said interior volume for suspending said amount of raw material in an agitated aqueous solution;
c) wherein within said agitated aqueous solution the amount of raw material dissociates into a plurality of constituent parts;
d) at least one source of a plurality of conditioning chemicals penetrating into the interior volume;
e) a crusher disposed at the bottom of the interior volume for receiving and crushing said plurality of constituent parts into an aqueous solution of fines; and,
f) means for transporting said aqueous solution of fines from said crusher to an at least one final treatment device.

2) The system of claim 1 further comprising a second source of high pressure water comprising recycled water from the crusher.

3) The system of claim 2 wherein the agitated aqueous solution comprises a surface floating hydrocarbon froth component and wherein the system further comprises a froth skimmer for skimming said surface floating hydrocarbon froth from the vessel for further treatment.

4) The system of claim 3 wherein said plurality of conditioning chemicals comprises a suitable metered amount of a dispersant and a flocculating agent.

5) The system of claim 4 wherein said means for transporting the fines from the crusher to said final treatment sequence comprises a cyclonic dryer wherein said cyclonic dryer separates the aqueous solution of fines into an aqueous component for recycling to the agitation chamber and a slurry component containing the fines for transportation to said final treatment device.

6) The system of claim 5 wherein said slurry component is pumped to the at least one final treatment device.

7) The system of claim 6 wherein the at least one final treatment device is a sand washing device.

8) The system of claim 6 wherein the final treatment device comprises an at least one tank separated into a plurality of treatment cells by a plurality of separating walls and wherein said plurality of treatment cells are aligned serially in a linear fashion.

9) The system of claim 8 wherein said at least one tank has a first slurry receiving cell and a last clean product cell.

10) The system of claim 9 wherein the tank further includes an auger device penetrating said each of the plurality of treatment cells and said plurality of separating walls so that as said auger device rotates the slurry is agitated and moved from said first slurry receiving cell to said last clean product cell.

11) The system of claim 10 wherein each of the treatment cells further includes a first pot connected to each of the treatment cells by an overflow conduit for a first separation of water from hydrocarbon.

12) A method for pre-treatment of drill cuttings contaminated by hydrocarbons, said method comprising the following steps:
a) Feeding an amount of said drill cuttings into an agitation chamber having an interior volume;
b) Washing the drill cuttings with at least one source of high pressure water thereby creating an agitated aqueous solution comprising a plurality of constituent parts of drill cuttings;
c) Introducing a suitable solution of a plurality of conditioning chemicals;
d) Crushing said plurality of constituent parts of drill cuttings into an aqueous solution of fines; and,
e) Separating said aqueous solution of fines by cyclonic treatment into a water solution and slurry containing said fines.

13) The method of claim 12 further comprising creating a floating froth of hydrocarbon on said agitated aqueous solution and skimming said floating froth from the agitated aqueous solution.

14) The method of claim 13 further comprising the step of recycling said water solution to said agitation chamber.

15) The method of claim 14 further comprising the step of pumping said slurry a final treatment device for a final treatment.

16) The method of claim 15 wherein said final treatment comprises the following steps:
a) Providing a series of agitation cells;
b) Receiving the slurry at a first end of said series;
c) Providing an agitation device for continual agitation of the slurry in the series of agitation cells;
d) Moving the slurry from said first end to a final agitation cell;
e) Draining off any hydrocarbon that collects on the surface of the series of agitation cells.
